(19) United States
(12) Patent Application Publication
(10) Pub. No.: US 2023/0406712 A1
(43) Pub. Date: Dec. 21, 2023

(54) Method and System for Processing a Fluid

(71) Applicant: Blanco Futures, LLC, Houston, TX (US)

(72) Inventors: Matthew White, Houston, TX (US); Paul Englram, Burr Ridge, IL (US)

(21) Appl. No.: 18/208,337

(22) Filed: Jun. 12, 2023

Related U.S. Application Data
(60) Provisional application No. 63/352,968, filed on Jun. 16, 2022.

(51) Int. Cl. C01B 32/60; C02F 1/465

(52) U.S. Cl. CPC C01B 32/60; C02F 1/465; C02F 2101/10

(57) ABSTRACT

A process for treating a source fluid in a manner that results in converting a carbon constituent into a carbonate constituent. The process includes the steps of providing the source fluid to a first treatment step, the source fluid being aqueous and comprising: at least one ppm to no more than five percent (by volume) of a hydrocarbonaceous component, and an impurity that includes a metal, a hard mineral, and combinations thereof. The process includes reacting the source fluid via the first treatment step to produce a treated aqueous stream comprising at least one percent to no more than thirty percent (by volume) of a hydroxide constituent.

### STATEMENT REGARDING FEDERALLY SPONSORED RESEARCH OR DEVELOPMENT

Not applicable.

### BACKGROUND

### Field of the Disclosure

This disclosure relates to making a carbon receptive stream from an aqueous-organic waste stream. Particular embodiments pertain to making and using a product stream obtained from processing a hydrocarbonaceous water stream to sequester, capture, or convert carbon dioxide (CO₂).

### Background of the Disclosure

If human beings have one area of consistent commonality, it is in creating waste. The creation of wastewater has been the bane of industry since its beginning. Wastewater treatment is essential for preventing disease and protecting the environment, but current treatment processes are energy intensive and emit greenhouse gases due to fossil fuel use and organic degradation.

It has been reported that every year approximately 12 trillion gallons of municipal wastewater are treated in the U.S. These numbers are even larger when industrial and agricultural wastewater treatment industries are included. Even after treatment, wastewater must often be disposed in some form or fashion, as effective re-use of wastewater is presently limited, mainly as a result of cost considerations.

CO₂ emissions are also problematic as a result of the impact on the environment. The emission of CO₂ occurs from natural and human activities. The natural order of things has resulted in balance of CO₂ emission and removal—for example, animals produce CO₂ as a result of eating vegetation, while the same vegetation uses CO₂ in order to grow. However, since the time of the industrial revolution human beings have increasingly disrupted the balance by emitting CO₂ without previous concern on removal (approximately 60% total CO₂ emission is due to fossil-fuel use). Only recently has consideration of CO₂ removal taken on greater consequence.

Point-source carbon dioxide mitigation, in particular carbon capture and storage (CCS), is now utilized for reducing industrial and energy-related CO₂ emissions. Conventional CCS consists of energy-intensive and costly CO₂ separation, purification, compression, transportation, and injection underground that increase operating costs by as much as 40% (or sometimes more).

Related CCS technologies have been explored to capture much more dilute CO₂ from the atmosphere, usually in some form of bio-related techniques. Generally, these are even more energy intensive and costly than point-source CO₂ mitigation. Despite progress, most current CO₂ capture technology limits the applicability of CO₂ capture to new emissions without tackling the Giga tons of cumulative anthropogenic CO₂ emissions that exist and already pose a great threat to the climate.

It is estimated that even if 90% of CO₂ emitted from 90% of the point sources is captured, 50% of the total anthropogenic CO₂ emission will still be unaccounted for. This stresses the importance of ambient CO₂ capture. Currently, feasible ambient CO₂ capture technologies are hampered by the high energy requirements of the process, and the lack of safe carbon storage options.

There is a need in the art for new, cost-effective, and safe methods of capturing or otherwise reducing CO₂ density. Additionally, there is a need in the art for new methods of wastewater treatment and processing, especially methods that process an organic-aqueous mixture in manner suitable to facilitate sequester, capture, or convert CO₂.

### SUMMARY

Embodiments herein may be useful for a process for making and/or using, treating, etc. a source fluid in a manner that results in converting a carbon constituent into a carbonate constituent. The process may include providing the source fluid to a first treatment or pre-treatment step, the source fluid being aqueous. The source fluid may include at least one ppm to no more than five percent (by volume) of a hydrocarbonaceous component, and no more than 50,000 ppm of another impurity that includes a metal(s), a hard mineral(s), and combinations thereof. In aspects, the another impurity may be no more than 3,000 ppm.

The process may include reacting the source fluid via the first treatment step to produce a treated aqueous stream comprising of at least one percent to no more than thirty percent (by volume) of a hydroxide constituent.

The process may include providing the treated aqueous stream and an air stream comprising the carbon constituent to a neutralization reactor, wherein the carbon constituent and the hydroxide constituent are reactive to a point whereby at least 90% (by weight) of the carbon constituent is converted to the carbonate constituent.

In aspects, the source fluid comprises produced water, wastewater, brine, and combinations thereof. The hydroxide component may include one of potassium hydroxide, calcium hydroxide, sodium hydroxide, and combinations thereof. The air stream may include atmospheric air consisting of at least 200 ppm to no more than 500 ppm carbon dioxide. The carbonate constituent may include one of potassium bicarbonate, calcium bicarbonate, sodium bicarbonate, and combinations thereof.

In aspects, prior to the first treatment step, the source fluid is pre-treated with an electrocoagulation or other separation process to reduce the amount of metal, hard mineral, and combinations thereof below 3,000 ppm.

Prior to the first pretreatment step, the source fluid may be pre-treated with dissolved air flotation, microgas, or other suitable operation.

These and other embodiments, features and advantages will be apparent in the following detailed description and drawings.

### BRIEF DESCRIPTION OF THE DRAWINGS

A full understanding of embodiments disclosed herein is obtained from the detailed description of the disclosure presented herein below, and the accompanying drawings, which are given by way of illustration only and are not intended to be limitative of the present embodiments, and wherein:

FIG. 1A shows an overview block flow diagram of a process for treating a fluid according to embodiments of the disclosure;

FIG. 1B shows an overview block flow diagram of a process for concentrating a fluid according to embodiments of the disclosure; and

FIG. 2 shows a schematic flow diagram of a process for treating a fluid according to embodiments of the disclosure.

### DETAILED DESCRIPTION

Herein disclosed are novel apparatuses, systems, and methods that pertain to a carbon capture and storage, details of which are described herein.

Embodiments of the present disclosure are described in detail with reference to the accompanying Figures. In the following discussion and in the claims, the terms “including” and “comprising” are used in an open-ended fashion, such as to mean, for example, “including, but not limited to . . . ”. While the disclosure may be described with reference to relevant apparatuses, systems, and methods, it should be understood that the disclosure is not limited to the specific embodiments shown or described. Rather, one skilled in the art will appreciate that a variety of configurations may be implemented in accordance with embodiments herein.

Although not necessary, like elements in the various figures may be denoted by like reference numerals for consistency and ease of understanding. Numerous specific details are set forth in order to provide a more thorough understanding of the disclosure; however, it will be apparent to one of ordinary skill in the art that the embodiments disclosed herein may be practiced without these specific details. In other instances, well-known features have not been described in detail to avoid unnecessarily complicating the description. Directional terms, such as “above,” “below,” “upper,” “lower,” “front,” “back,” etc., are used for convenience and to refer to general direction and/or orientation, and are only intended for illustrative purposes only, and not to limit the disclosure.

Connection(s), couplings, or other forms of contact between parts, components, and so forth may include conventional items, such as lubricant, additional sealing materials, such as a gasket between flanges, PTFE between threads, and the like. The make and manufacture of any particular component, subcomponent, etc., may be as would be apparent to one of skill in the art, such as molding, forming, press extrusion, machining, or additive manufacturing. Embodiments of the disclosure provide for one or more components to be new, used, and/or retrofitted to existing machines and systems.

Various equipment may be in fluid communication directly or indirectly with other equipment. Fluid communication may occur via one or more transfer lines and respective connectors, couplings, valving, and so forth. One or more valves may need to be opened so that respective components transfer into the gun assembly. Fluid movers, such as pumps, may be utilized as would be apparent to one of skill in the art.

Numerical ranges in this disclosure may be approximate, and thus may include values outside of the range unless otherwise indicated. Numerical ranges include all values from and including the expressed lower and the upper values, in increments of smaller units. As an example, if a compositional, physical or other property, such as, for example, molecular weight, viscosity, melt index, etc., is from 100 to 1,000. it is intended that all individual values, such as 100, 101, 102, etc., and sub ranges, such as 100 to 144, 155 to 170, 197 to 200, etc., are expressly enumerated. It is intended that decimals or fractions thereof be included. For ranges containing values which are less than one or containing fractional numbers greater than one (e.g., 1.1, 1.5, etc.), smaller units may be considered to be 0.0001, 0.001, 0.01, 0.1, etc. as appropriate. These are only examples of what is specifically intended, and all possible combinations of numerical values between the lowest value and the highest value enumerated, are to be considered to be expressly stated in this disclosure. Numerical ranges are provided within this disclosure for, among other things, the relative amount of reactants, surfactants, catalysts, etc. by itself or in a mixture or mass, and various temperature and other process parameters.

The term “water” as used herein can refer to the main constituent for a frac fluid, and can include fresh water, seawater, produced water, treated variations thereof, mixes thereof, etc., and can further include impurities, dissolved solids, ions, salts, minerals, and so forth. Water for the frac fluid can also be referred to as ‘frac water’.

The term “produced water” as used herein can refer to water recovered from a subterranean formation or other area near the wellbore. Produced water can include ‘flowback water’, which is water recovered from the subterranean formation after a frac operation.

The term “chemical” as used herein can analogously mean or be interchangeable to material, chemical material, ingredient, component, chemical component, element, substance, compound, chemical compound, molecule(s), constituent, and so forth and vice versa. Any ‘chemical’ discussed in the present disclosure need not refer to a 100% pure chemical. For example, although ‘water’ may be thought of as H2O, one of skill would appreciate various ions, salts, minerals, impurities, and other substances (including at the ppb level) may be present in ‘water’. As used with respect to a chemical, unless specifically indicated otherwise, the singular includes all isomeric forms and vice versa (for example, “hexane”, includes all isomers of hexane individually or collectively).

The term “treatment” (or treating, treated, treat, etc.) as used herein may refer to an action or act such as purifying, reacting, transferring, separating, charging, heating, drying, cleaning, and so forth. One example may include ‘treating’ a multi-phase fluid to separate phases. Another example may include ‘treating’ a substantially aqueous (water) stream to remove a non-aqueous component. The act may be the result of an automated or manually controlled piece of equipment working separately or in combination with other components. The term ‘treatment’ may be analogous or equivalent to process(ing), handling, etc.

The term “neutralization” as used herein can refer to a reaction between an acid-based material and a base-based material to form water and a salt(s), the resulting solution being characterized by a PH level.

The term “agglomerate” as used herein may refer to an additive or constituent that may aid or facilitate the clumping of materials together into a floc, which may float to the top of a liquid (creaming), settle to the bottom of the liquid (sedimentation), or be readily filtered from the liquid. For example, water may have iron in the presence of 10 ppm to 100 ppm that may be agglomerated for removal. Iron may be charged with other chemistry to make it more attractive to an agglomerate.

The term “microgas” as used herein may refer to the presence of a gas dispersed in a liquid resulting in bubbles. The term ‘microgas’ may be analogous or equivalent to ‘microbubbles’. Generally, the 95% of bubbles may have a diameter less than 100 microns. An average bulk density of bubbles may have a diameter less than 100 microns. The microbubbles may have an average bulk diameter less than 100 microns.

The term “flash mixer” as used herein may refer to equipment or process step whereby a mixer is used to uniformly disperse and blend chemicals, such as coagulant aids, and the like, into a feed stream. These chemicals, either in solution or slurry form, may be added to aid in the removal of solids and other contaminants. The flash mixer may run with variable speed to ensure proper mixing to specification.

The term “tube settler” as used herein may refer to equipment or process step whereby one or more tubes (adjacent respective tubes) are used in a gravity separation process. The tubes are not limited to any particular shape, and may vary.

The term “salt” as used herein can refer to an ionic compound. A salt can be formed via a neutralization reaction. A salt can be electrically neutral (i.e., no net charge).

The term “carbon capture” as used herein may refer to conversion of CO₂ into another form, such as a (bi)carbonate like NaHCO₃

Embodiments herein may pertain to a process, system, etc. for treating a fluid in a manner that facilitates carbon sequester and storage. Any part or piece of equipment of systems, methods, processes, apparatus, etc. described herein may be operably configured to accomplish a desired result, regardless whether expressly indicated. For example, one ‘step’ may be coupled with another ‘step’, such as via fluid communication commonly accomplished via piping, tubing, etc. Any part or piece may have or be associated with sensors, gauges, valves, piping, control scheme, along with any necessary auxiliary equipment, such as pumps, heat exchangers, mixers, and the like. Any part or piece may include or be associated with a pressure vessel, a reactor, an atmospheric container, a storage tank, and the like. Any ‘stream’ may be or include a bypass, a branch (split), a recycle, and so forth, and may be single phase, multi-phase, slurry, solid, liquid, etc. Any embodiment herein may be batch, continuous, or combinations thereof.

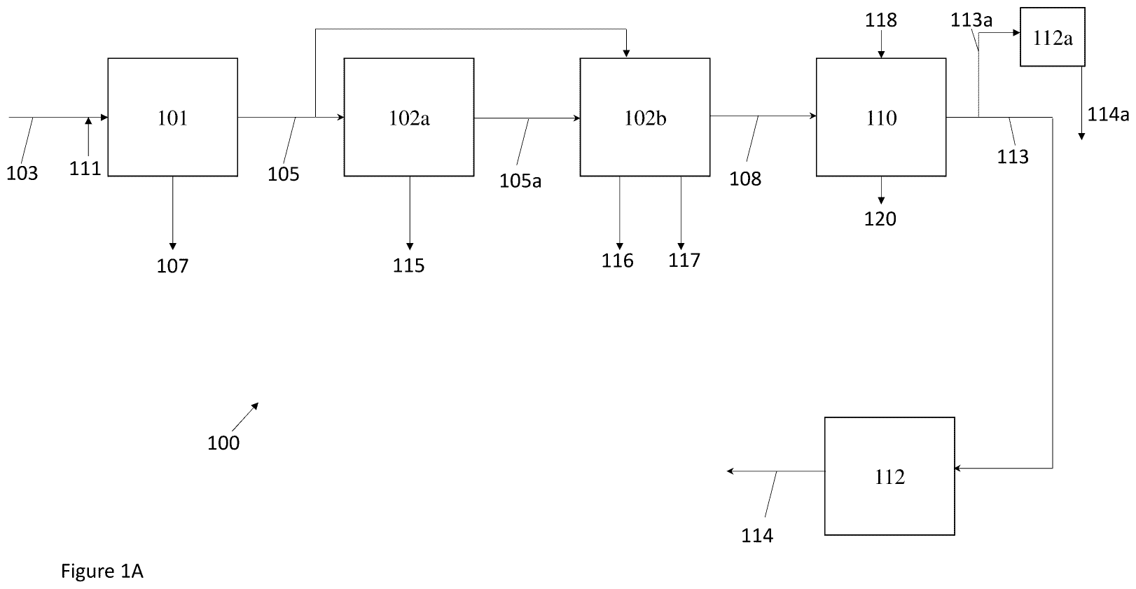

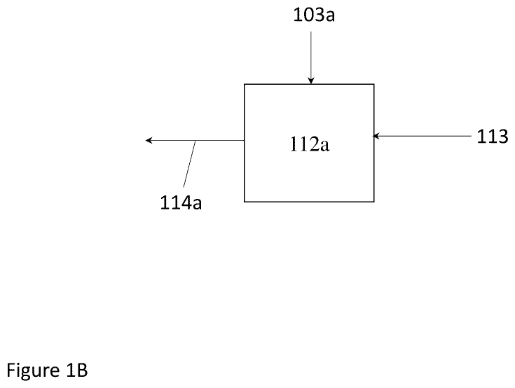

Referring now to FIGS. 1A and 1B, an overview flow diagram of a process (or sometimes ‘system’) for treating a fluid, and a diagram for a concentration step, in accordance with embodiments disclosed herein, are shown. FIGS. 1A and 1B together illustrate a process (or method, system, etc.) 100 suitable for making a chemical product 114 (which may be in solid and/or liquid form) that results in or is useful for sequestration and storage of carbon. The chemical product 114 may equivalently be referred to as ‘final product’, ‘blend product’, ‘composition of matter’, and other comparable variations.

### Preliminary Processing

Preliminary processing step 101 may include a treatment or pre-treatment process useable with feed stream 103. The feed stream 103 may be an aqueous stream from a source, such as a pond, lake, tank, etc. The feed stream 103 may be produced water, waste water, brine, and so forth. The stream 103 may be oily in that the stream may include a hydrocarbonaceous constituent. The hydrocarbonaceous constituent may be present in the range of 1 ppm to 5% (by volume). In embodiments, the upper limit may be about 10% by volume hydrocarbonaceous constituent. This type of oily-aqueous stream is notorious for a complete lack of usefulness in the industry, and hence why it is a waste stream.

The processing step 101 may be a separation step, including physical or chemical separation, or in some instances a combination thereof, or other form of treatment. As one example, the processing step 101 may include dissolved air floatation (DAF), which may be suitable to treat stream 103 to remove suspended matter, such as oil or solids. As the term ‘step’ is used herein, step may refer to a unit operation or other form of equipment (or operably connected pieces of equipment) suitable to perform the ‘step’. Thus, the first processing step 101 may utilize a DAF unit (or its operation thereof).

Although referenced as ‘air’ (including but not limited to atmospheric air), any type of gas may be used that results in synergy of some amount of desired floatation, but also some amount of remnant (but not permanent) diffusion into the feed stream 103. For example, other gases such as natural gas (or methane), nitrogen, recycled or vented gas from process 100, or the like, may be used.

Smaller bubbles have a longer infusion within the fluid to create better adhesion to the oil particles. Larger bubbles may have reduced time within solution, and result in less efficient separation. It has been discovered that a microgas or microbubble solution having 95% or greater average bulk density bubble size in a bubble size range (by diameter) of 20 microns to 100 microns.

Thus, as another option, the processing step 101 may include a microgas process. This is not a DAF system. Once the hydrocarbonaceous constituent is removed to spec, then treated stream 105 may flow to processing 102a and 102b, where that stream 105 may then be treated to remove other material such as divalent cations and solids.

As such, removal of contaminants may occur by first dispersing a gas into a source of liquid to form a solution having microbubbles 111 that may then be mixed or otherwise injected into the feed stream 103. Within the processing step 101, the bubbles 111 may have a net charge that results in adhering to contaminants in the feed stream causing contaminants to float to the surface. This floated residue may then be removed by a skimming device or the like. Some amount of bulk average residence time may be of benefit.

Removal may occur by dissolving air in the stream 103 (such as under pressure) and then releasing the air at atmospheric pressure in a flotation tank basin. The released air may form tiny bubbles that may adhere to the suspended matter causing the suspended matter to float to the surface of the stream 103 where it may then be removed by a skimming device or the like.

The processing step 101 may result in a first treated stream 105, which may be a salty aqueous stream. There may also be a resultant byproduct or waste stream 107. The waste stream 107 may include some or most of the hydrocarbonaceous component that may be removable, whereby the stream 107 or a portion thereof, may be reusable (such as a fuel source for a combustion reaction). Just the same, the byproduct stream 107 may be discarded, vented, stored (for later sale or use), recycled, further treated or processed, etc. The waste stream 107 may be or include solids removed or reacted out from the feed stream 103.

### Secondary Processing

The first processing step 101 may be optional. In this respect, it may be the case that feed stream 103 feeds directly to secondary processing 102 a and/or b. As described and shown here, the first treated stream 105, aqueous in nature, may be further processed, such as in a secondary processing step 102a. The first processing step 101 may be sufficient to remove certain constituents, while other undesired constituents 115 remain in the treated stream 105. For example, the first treated stream 105 may have a higher-than-desired amount of metal (e.g., iron), which may be problematic in other areas of the system 100.

Just the same, it may be desirous to remove certain (valuable) constituents 115 out of the treated stream 105 before the stream is made ready for CSS processing, and thus in an analogous manner the secondary process step 102a may be used.

In embodiments, the secondary processing step 102a may be or include filtration. In other embodiments, the secondary processing step 102a may be an electrocoagulation treatment, which may be combined with high pH softening to greatly reduce unwanted materials, such as (divalent) cations. The secondary processing step 102a may include a physical change to the stream 105, a chemical change, or combinations thereof. Whatever the case may be, the secondary processing step 102a may be used to create or result in a secondary treated stream 106.

Secondary processing may further include (another) secondary processing step 102b, which may be, for example, an electrolysis treatment. As such, the secondary processing 102b may be a plate-frame electrolysis unit. The processing 102b may be configured and operable to produce a hydroxide constituent, such as via the following: 2NaCl+2H₂O→2NaOH+Cl₂+H₂

Depending on system conditions and requirements, either or both of the first treated stream 105 and the second treated stream 105a may be fed to the secondary processing step 102b. In some instances the feed stream 103 may be fed to the secondary processing step 102b. What is fed to the secondary processing step 102b may depend on a specification, such as metal or mineral content. In embodiments, either or both of the first treated stream 105 and the second treated stream 105a may have a metal or hard mineral content (or combination thereof) in a range of about 50 ppm to no more than about 50,000 ppm. In aspects, the range may be no more than 3,000 ppm.

As an example: the upper end specification may be met by first using processing 102a, which may be electrocoagulation or DAF. Once the spec is met, the treated stream 105a may be fed to processing 102b, which may be electrolysis.

The secondary processing step 102b may result in one or more product streams. For example, there may be a first product stream 108, a second product stream 116, and a third product stream 117. The first product stream 108 may be aqueous with a hydroxide constituent. The first product stream 108 may have about 1% to about 30% (by volume) of the hydroxide constituent. The hydroxide constituent may be, for example, sodium hydroxide (NaOH), potassium hydroxide (KOH), other hydroxides, or combinations thereof, etc.

The second product stream 116 may be predominantly chlorine-based. The chlorine-based stream may be processed into gas, liquid or solid state, or combinations thereof, whichever might be desired. The second product stream 116 may be transferred for further processing, or sent out of the system 100, such as to a customer or waste disposal. The chlorine-based stream may have other uses, such as treatment of water and the like.

The third product stream 117 may be predominantly hydrogen-based. The third product stream 117 may be transferred for further processing, or sent out of the system 100, such as to a customer or waste disposal. In some embodiments, the hydrogen-based stream may be burned, and thus used as a fuel source to power any portion of the system 100. In other embodiments, the stream 117 (or a portion thereof) may be used for further reaction. For example, hydrogen from 117 may be reacted with chlorine from 116 in order to form a HCL-product.

### Neutralization/Carbon Capture

The first product stream 108 may be transferred to a carbon capture unit 110. The carbon capture unit 100 may be an atmospheric or pressurized vessel, a reactor (e.g., reactive column), or the like, whereby the first product stream 108 is fed thereinto. At the same time, there may be a carbon source 118 transferred to the unit 110. The carbon source 118 may be air.

In embodiments, the carbon source 118 may be atmospheric air, which may be fed to the unit 110 via a blower or fan (not shown here). The carbon source may be gaseous in nature, with an approximate carbon constituent density of about 200 ppm to about 500K ppm. In embodiments, the amount of carbon may be about 350 ppm to about 450 ppm. The ‘carbon’ may be from CO₂ as it exists in the atmospheric air.

The carbon capture unit 110 may be configured and operated to accommodate a reaction and/or separation of streams 108, 118, and in this sense ‘capture’ may be analogous to ‘conversion’. For example, the carbon source stream 118 may be reactive with the first product stream 108, such as via a neutralization reaction. For example, the following reaction may occur in the presence of NaOH: 2 NaOH+CO₂→Na2CO₃ (aq)+H₂O (l). Or as another example: CO₂+NaOH (aq)→NaHCO₃ (aq). Other intermediates may be formed that also result in H₂O

The processed stream 113 may be an aqueous (bi)carbonate stream, and free (or have a reduced amount) of CO₂. In embodiments, the processed stream 113 may be separated by phase. For example, stream 113 may be liquidious in nature, whereas stream 113a may be dry or slurry.

Any CO₂ (including remnant or unreacted) from source 118 may also be concentrated, and disposed, such as via injection 120. The CO₂ may also be recycled. However, it is contemplated that there may be high conversion of CO₂ from source 118, such as 99% or higher.

### Final Processing

The majority of the excess fluid from the process may be high in pH and may be returned to 105 to be used to increase the pH of the feed stream 103 to assist the softening process, any solids form this will be removed in the 115 stream. The carbonate stream 113 may be sent to final processing 112. The final processing 112 may include finishing operations, such as evaporation, concentration, (solids) separation, and the like.

In an embodiment, the carbonate stream 113 may be maintained in liquid form, and via concentration step 112a, concentrated into a liquid brine stream 114a. Concentration may occur, for example, from a drying or evaporation process. The resultant brine stream 114a, which would normally be a waste stream on its own, may now be used to dispose of CO₂ as it exists in its new bicarbonate form.

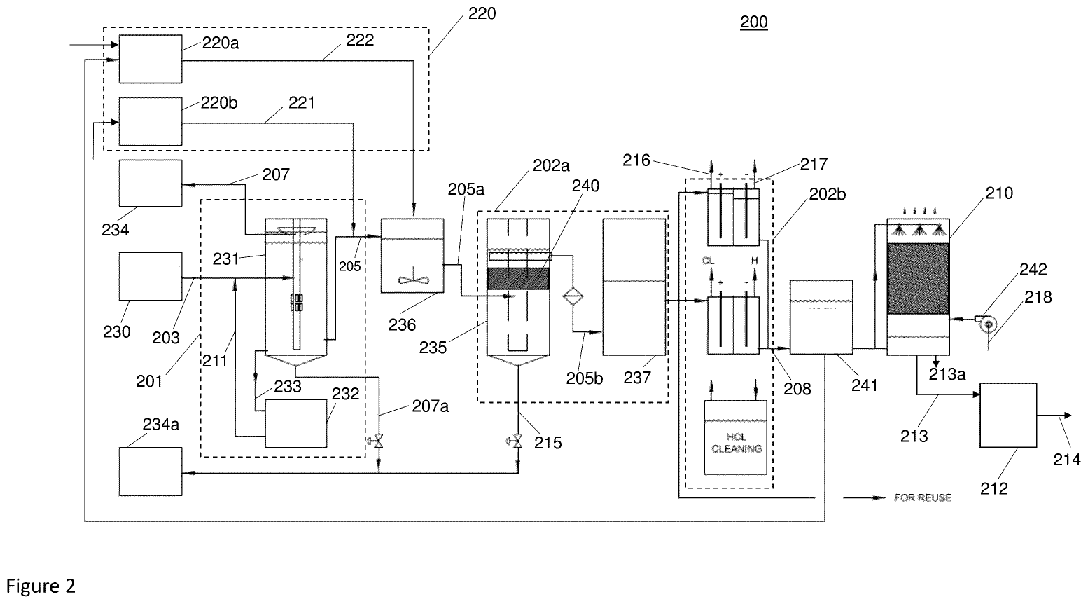

Referring now to FIG. 2, a schematic flow diagram of a process (or sometimes ‘system’) for treating a fluid, in accordance with embodiments disclosed herein, is shown. FIG. 2 illustrates a process 200 suitable for making a chemical product 214 (which may be in solid or liquid form) that results in or is useful for sequestration and storage of carbon. The chemical product 214 may equivalently be referred to as ‘final product’, ‘blend product’, ‘composition of matter’, and other comparable variations.

### Preliminary Processing

Preliminary processing step 201 may include a treatment or pre-treatment process useable with feed stream 203. The feed stream 103 may be an aqueous stream from a source 230, such as a pond, lake, tank, etc. The feed stream 203 may be produced water, waste water, brine, and so forth. The stream 203 may be oily in that the stream may include a hydrocarbonaceous constituent. The hydrocarbonaceous constituent may be present in the range of 1 ppm to 5% (by volume). In embodiments, the upper limit may be about 10% by volume hydrocarbonaceous constituent. This type of oily-aqueous stream is notorious for a complete lack of usefulness in the industry, and hence why it is a waste stream. These streams typically are pumping into a disposal wells which add cost to the management of this wastewater.

The preliminary processing step 201 may receive the feed stream 203 that may be overly emulsified with oil and other contaminants, and thus a standard gravity-type separation may be ineffective. As such, the processing of the feed stream 203 may require an additional boost or kick to drive separation.

As the term ‘step’ is used herein, step may refer to a unit operation or other form of equipment (or operably connected pieces of equipment) suitable to perform the ‘step’. The first processing step 201 may utilize floatation (akin to dissolved air floatation [DAF] or other separation such as the microgas separation as previously referred to), which may be suitable to treat fluid 203 to remove suspended matter, such as oil or solids. Thus, the step 201 may include a step unit 231 that may be a separation unit configured to facilitate floatation (or its operation thereof). Although referenced as ‘air’ (including but not limited to atmospheric air), any type of gas may be used that results in an infusion effect with the feed stream 203, including nitrogen, natural gas, field gas, recycled gas, and the like.

On the one hand it may be the case that a larger gas bubble (diameter) is desired in order to provide the float effect; however, for embodiments herein it may not be the case, as instead, greater retention time within the unit 231 may be beneficial, and thus a smaller gas bubble is desired.

Removal of contaminants may occur by first dispersing a gas into a source of floatation liquid to form a solution having microbubbles 211 that may then be mixed or otherwise injected into the feed stream 203. The unit 132 may be operably coupled with a microgas unit 232. The microgas unit 232 may include various equipment, such as valve, pump, etc. to create a gaseous solution.

Although not shown in detail here, the gas unit 232 may include a pump operable to draw a liquid 233 (which may come from unit 231) and increase pressure through a valve and vacuum transducer that results in a controlled vacuum to the pump inlet. This may then allow gas (e.g., air) to be drawn into the liquid. The resultant gas solution may be pumped into a microgas tank (generally about 100 psi). The outbound flow from the tank may be regulated so that a desired amount of the solution may be mixed to the feed stream 203. Any undesired buildup within the tank may be vented.

The operation of the microgas unit 232 may be suitable to control or determine bubble size within the solution. Generally, the bubble size may be sub-100 micron. It may be desirous to have a bubble of some size to provide a lifting effect and thus not too small that the gas is completely infused into the feed stream 203. In the event of nanobubbles or smaller, there may not be adequate lifting and separation in the unit 231.

Within the unit 231, the bubbles 211 may have a net charge that results in adhering to contaminants in the feed stream 203 causing contaminants to float to the surface. This floated residue may then be removed by a skimming device or the like. Some amount of bulk average residence time may be of benefit. Normal range of feed through the process 200 may be 20,000 bpd to 40,000 bpd through the system. Bulk average residence time of the feed fluid in the unit 203 may be about 30 minutes to 60 minutes.

The processing step 201 may result in a first treated stream 205, which may be a salty aqueous stream. There may also be a resultant byproduct or waste stream 207. The waste stream 207 may include some or most of the hydrocarbonaceous component that may be removable, whereby the stream 207 or a portion thereof, may be reusable (such as a fuel source for a combustion reaction). The first waste stream 207 may transferred to an interim or final waste destination 234. Just the same, there may be another or second byproduct stream 207a suitable to be discarded, vented, stored (for later sale or use), recycled, further treated or processed, etc via second waste destination 234a. The second waste stream 207a may be or include solids removed or reacted out from the feed stream 203.

### Secondary Processing

The first processing step 201 may be optional. In this respect, it may be the case that feed stream 203 feeds directly to secondary processing 202 a and/or b. As described and shown here, the first treated stream 205, aqueous in nature, may be further processed, such as in a secondary processing step 202a. The first processing step 201 may be sufficient to remove certain constituents, while other undesired constituents 215 remain in the treated stream 205. For example, the first treated stream 205 may have a higher-than-desired amount of metal (e.g., iron), which may be problematic in other areas of the system 200.

Just the same, it may be desirous to remove certain (valuable) constituents 215 out of the treated stream 205 before the stream is made ready for CSS processing, and thus in an analogous manner the secondary process step 202a may be used.

For example, the first treated stream 205 may have a higher-than-desired amount of metal (e.g., iron), which may be problematic. As described and shown here, the first treated stream 205 (which could be the feed stream 203), may be further processed, such as in a secondary processing unit 235.

It may be desirous to remove remnant constituents out of the treated stream 205 or further process the treated stream 205 to further specification. Prior to the secondary unit 235, the first treated stream 205 may thus directed to an intermediate unit 236, such as a flash mixer, for blending with one or more additives.

The mixer 236 may be a flash mixer to accommodate rapid blending of the treated fluid 205 with one or more additives 221, 222 provided from additive skid 220. Example additives 221, 222 may include an oxidizer, an agglomerate, a caustic, a polymer, and the like. There may be one or more respective additive feed sources 220a, 220b, etc. The additives from the respective sources 220a, 220b may be mixed directly into the treated stream 205, provided to the intermediate unit 236, or may be mixed with one another prior to mixing into the treated stream 205, as may be desired.

The use of additives 220a, 220b may depend on the desired specification of product 214. A control skid (not viewable here) may be configured with pumps, metering, etc. operable to transfer and control additive feed from the skid 220 to the first treated stream 205 or unit 236. Just the same, if additives are unnecessary, the treated stream 205 may bypass or pass through the unit 236. Thus, intermediate mixed fluid 205a may or may not include additives, and may simply be the composition of stream 205.

The unit 235 that receives the stream 205a may be a clarifier unit or vessel (and could be multiple clarifiers in series or parallel). The clarifier 235 may be operable to create or result in the secondary treated stream 205b.

Of note the equipment and units of process 200 need not be static flat bottom tanks. Instead, there may be an active and dynamic operation through units 231, 235 that may include removal of solids or slurry 207a, 215. This type of configuration may facilitate improved solids management and handling, and all but eliminate expensive solids maintenance. For example, remnant solids will naturally flow to a bottom-most point within the units, which may then be drawn off for removal via piping and respective solids pump(s) and transferred to solids waste destination 234a.

Although not shown in detail here, the unit 235 may have one or more partitions or baffles, which may extend laterally from one sidewall of the clarifier to an opposite sidewall thereof. As the stream 205 flows downward in a feed zone, the fluid may come into contact with a layer of packing 240. The packing 240 may be tubular packing or promote tubular settling. This type of packing 240 is not of use in the oilfield industry, as it is known readily plug and foul as a result of oil.

The packing 240 may include tubular-type structure oriented at an angle μl with respect to a reference or axis (not shown here). The structure of the packing 240 may be based upon placement of multiple corrugated sheets next to each other. Other configurations are possible. The packing 240 may be a durable material, such as made from PVC or polypropylene plastic. The packing 240 may be held in place, such as mechanically held in place. The packing may be made from a plastic with a density greater than water to hold in place.

In embodiments, the secondary processing step 202a may be or include filtration. In other embodiments, the secondary processing step 202a may include a physical change to the stream 205, a chemical change to the stream 205, or combinations thereof. Whatever the case may be, the secondary processing step 202a may be used to create or result in a secondary treated stream 205b. From the unit 235 the secondary treated fluid 205b may be transferred and fed to a transfer or storage tank 237.

Secondary processing may further include another or alternative secondary processing step 202b, which may be, for example, an electrolysis treatment. As such, the secondary processing 202b may be a plate-frame electrolysis unit(s). The processing 202b may be configured and operable to produce a hydroxide constituent, such as via the following: 2NaCl+2H₂O→2NaOH+Cl₂+H₂

Depending on system conditions and requirements, either or both of the first treated stream 205 and the second treated stream 205b may be fed to the secondary processing step 202b. The step 202 may include a reactor operable to makes the caustic material usable to remove the carbon component. What is fed to the secondary processing step 202b may depend on a specification, such as metal or mineral content. In embodiments, one or all of the treated streams 205, 205a, 205b may have a metal or hard mineral (or combination) content in a range of about 50 ppm to no more than about 50,000 ppm. In aspects, the upper limit may be about 3,000 ppm. Once a desired spec is met, the treated stream 205b may be fed to processing 202b, which may be electrolysis.

202b may include an anode(s) and cathode(s) (which may be powered by, e.g., DC current indicated by the + and − as shown in the Figures. A separation membrane or diaphragm may facilitate separated chambers, which drive and ion flow toward the anode and the cathode. This energy flow may drive hydrogen-based sodium hydroxide to the cathode side and chlorine based compounds to the anode side of the cell from the sodium chloride in the solution. The secondary processing step 202b may include cleaning contaminants (metals, minerals, etc.) that might build up or appreciate over time on electrodes, membranes, or other equipment. The cleaning might use an HCL bath put on an automatic cycle, such as every 12 hours.

The secondary processing step 202b may result in one or more product streams. For example, there may be a first product stream 208, a second product stream 216, and a third product stream 217. The first product stream 208 may be aqueous with a hydroxide constituent. The first product stream 208 may have about 1% to about 30% (by volume) of the hydroxide constituent. The hydroxide constituent may be, for example, sodium hydroxide (NaOH), potassium hydroxide (KOH), other hydroxides, or combinations thereof, etc.

The second product stream 216 may be predominantly chlorine-based. The chlorine-based stream may be processed into gas, liquid or solid state, or combinations thereof, whichever might be desired. The second product stream 216 may be transferred for further processing, or sent out of the system 200, such as to a customer or waste disposal. The chlorine-based stream may have other uses, such as treatment of water and the like.

The third product stream 217 may be predominantly hydrogen-based. The third product stream 217 may be transferred for further processing, or sent out of the system 200, such as to a customer or waste disposal. In some embodiments, the hydrogen-based stream may be burned, and thus used as a fuel source to power any portion of the system 200. In other embodiments, the stream 217 (or a portion thereof) may be used for further reaction. For example, hydrogen from 217 may be reacted with chlorine from 216 in order to form a HCL-product.

The system may include oil skim dish automation. This configuration may substantially or completely remove the pad buildup that takes place in conventional oil water separators. Pad may be understood as a floating mat created from oil, iron oxide and other floating materials that builds into a semi solids mass, if not removed on a routine basis. There may be solids skim dish automation, such as on tank 231. There may be a dual system design for producing high quality water, removing higher amount of oil and solids for disposal and with the same system, from the touch screen convert to recycling water operation.

### Neutralization/Carbon Capture

The first product stream 208 may be transferred to a carbon capture unit 210 (via interim transfer or storage unit 241). The carbon capture unit 210 may be an atmospheric or pressurized vessel, a reactor (e.g., reactive column), or the like, whereby the first product stream 208 is fed thereinto. At the same time, there may be a carbon source 218 transferred to the unit 210. The carbon source 218 may be air blown into the carbon unit 210.

In embodiments, the carbon source 218 may be atmospheric air, which may be fed to the unit 210 via a blower or fan 242. The carbon source may be gaseous in nature, with an approximate carbon constituent density of about 200 ppm to about 500K ppm. In embodiments, the amount of carbon may be about 350 ppm to about 450 ppm. The ‘carbon’ may be from CO₂ as it exists in atmospheric air.

The carbon capture unit 210 may be configured and operated to accommodate a reaction and/or separation of streams 208, 218, and in this sense ‘capture’ may be analogous to ‘conversion’. For example, the carbon source stream 218 may be reactive with the first product stream 208, such as via a neutralization reaction. For example, the following reaction may occur in the presence of NaOH: 2 NaOH+CO₂→Na2CO₃ (aq)+H₂O (l). Or as another example: CO₂+NaOH (aq)→NaHCO₃ (aq). Other intermediates may be formed that also result in H₂O

The processed product stream 213 may be an aqueous (bi)carbonate stream, and free (or have a reduced amount) of CO₂. In embodiments, the processed stream 213 may be separated by phase. For example, stream 213 may be liquidious in nature, whereas stream 213a may be dry or slurry. A majority of this stream, which may be low in pH may be circulated back to the inlet of 220a to assist any (high) pH softening process.

Any CO₂ (including remnant or unreacted) from source 218 may also be concentrated, and disposed, such as via injection of outlet stream. The CO₂ may also be recycled. However, it is contemplated that there may be high conversion of CO₂ from source 218, such as 99% or higher.

### Final Processing

The carbonate stream 213 may be sent to final processing 212. The final processing 212 may include finishing operations, such as evaporation, concentration, (solids) separation, and the like.

Embodiments herein provide for a cost-effective, expedient, and scalable process that can be used to capture and store carbon dioxide. While embodiments of the disclosure have been shown and described, modifications thereof can be made by one skilled in the art without departing from the spirit and teachings of the disclosure. The embodiments described herein are exemplary only and are not intended to be limiting. Many variations and modifications of the disclosure presented herein are possible and are within the scope of the disclosure. Where numerical ranges or limitations are expressly stated, such express ranges or limitations should be understood to include iterative ranges or limitations of like magnitude falling within the expressly stated ranges or limitations. The use of the term “optionally” with respect to any element of a claim is intended to mean that the subject element is required, or alternatively, is not required. Both alternatives are intended to be within the scope of any claim. Use of broader terms such as comprises, includes, having, etc. should be understood to provide support for narrower terms such as consisting of, consisting essentially of, comprised substantially of, and the like.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the preferred embodiments of the disclosure. The inclusion or discussion of a reference is not an admission that it is prior art to the present disclosure, especially any reference that may have a publication date after the priority date of this application. The disclosures of all patents, patent applications, and publications cited herein are hereby incorporated by reference, to the extent they provide background knowledge; or exemplary, procedural or other details supplementary to those set forth herein.

What is claimed is:

1. A process for treating a feed stream in a manner that results in converting a carbon constituent into a carbonate constituent, the process comprising:
providing the feed stream to a first treatment step, the feed stream being aqueous and comprising: a hydrocarbonaceous component of at least one ppm to no more than ten percent (by volume), and an impurity of no more than 50,000 ppm in total of a metal, a hard mineral, and combinations thereof;
using the first treatment step to remove at least 99% (by volume) of the hydrocarbonaceous component from the feed stream to form a first treated stream;
using electrolysis to react the first treated stream to produce a treated aqueous stream comprising at least one percent to no more than thirty percent (by volume) of a hydroxide constituent; and
providing the treated aqueous stream and an air stream comprising the carbon constituent to a neutralization reactor,
wherein the carbon constituent and the hydroxide constituent are reactive to a point whereby at least some of the carbon constituent is converted to the carbonate constituent.

2. The process of claim 1, wherein the feed stream comprises produced water, waste water, brine, and combinations thereof.

3. The process of claim 1, wherein the hydroxide component comprises one of potassium hydroxide, calcium hydroxide, sodium hydroxide, and combinations thereof.

4. The process of claim 1, wherein the air stream comprises atmospheric air consisting of at least 200 ppm to no more than 500 ppm carbon dioxide.

5. The process of claim 1, wherein the carbonate constituent comprises one of potassium bicarbonate, calcium bicarbonate, sodium bicarbonate, and combinations thereof.

6. The process of claim 1, wherein the impurity in the first treated stream is below 3,000 ppm, and wherein the impurity in the first treated stream is at least 60% in solid phase.

7. The process of claim 1, wherein prior to the first treatment step, the feed stream is injected with microbubbles.

8. The process of claim 1, wherein the first treated stream is mixed with an additive that comprises one of an oxidizer, an agglomerate, a caustic, a polymer, and combinations thereof.

9. The process of claim 1, wherein the first treated stream is provided to a secondary processing step that comprises operating a clarifier with a layer of tubular packing, and the clarifier is configured with a skimming dish, wherein the skimming dish is disposed above a normal operation level of the clarifier.

10. A process for treating a feed stream in a manner that results in converting a carbon constituent into a carbonate constituent, the process comprising:
providing the feed stream to a first treatment step, the feed stream being aqueous and comprising: at least one ppm to no more than ten percent (by volume) of a hydrocarbonaceous component, and no more than 50,000 ppm of an impurity comprising a metal, a hard mineral, or combinations thereof;
providing a first treated stream from the first treatment step to a secondary processing step;
using electrolysis in the secondary processing step to produce a treated aqueous stream comprising at least one percent to no more than thirty percent (by volume) of a hydroxide constituent.

11. The process of claim 10, the process further comprising:
providing the treated aqueous stream and an air stream comprising the carbon constituent to a neutralization reactor, wherein the carbon constituent and the hydroxide constituent are reactive to a point whereby at least 90% (by weight) of the carbon constituent is converted to the carbonate constituent.

12. The process of claim 11, wherein the feed stream comprises produced water, waste water, brine, and combinations thereof.

13. The process of claim 12, wherein the hydroxide component comprises one of potassium hydroxide, calcium hydroxide, sodium hydroxide, and combinations thereof.

14. The process of claim 12, wherein the air stream comprises atmospheric air comprising at least 200 ppm to no more than 500 ppm carbon dioxide, and wherein the hydroxide component comprises one of potassium hydroxide, calcium hydroxide, sodium hydroxide, and combinations thereof.

15. The process of claim 14, wherein the carbonate constituent comprises one of potassium bicarbonate, calcium bicarbonate, sodium bicarbonate, and combinations thereof.

16. The process of claim 13, wherein prior to the first treatment step, the feed stream is pre-treated to reduce the impurity to below 3,000 ppm.

17. The process of claim 10 wherein the amount of the impurity in the feed stream is no more than 3,000 ppm.

18. The process of claim 17, wherein the first treatment step comprises dissolved air flotation.

19. A process for treating a feed stream in a manner that results in converting a carbon constituent into a carbonate constituent, the process comprising:
providing the feed stream to a treatment step, the feed stream being aqueous and comprising: at least one ppm to no more than ten percent (by volume) of a hydrocarbonaceous component, and no more than 30,000 ppm of an impurity comprising: a metal, a hard mineral, or combinations thereof;
using electrolysis to react the feed stream via the treatment step to produce a treated aqueous stream consisting of at least one percent to no more than thirty percent (by volume) of a hydroxide constituent;
providing the treated aqueous stream and an air stream comprising the carbon constituent to a neutralization reactor, wherein the carbon constituent and the hydroxide constituent are reactive to a point whereby at least some of the carbon constituent is converted to the carbonate constituent,
wherein the feed stream comprises produced water, waste water, brine, and combinations thereof,
wherein the hydroxide component comprises one of potassium hydroxide, calcium hydroxide, sodium hydroxide, and combinations thereof,
wherein the air stream comprises atmospheric air consisting of at least 200 ppm to no more than 500 ppm carbon dioxide, and
wherein the carbonate constituent comprises one of potassium bicarbonate, calcium bicarbonate, sodium bicarbonate, and combinations thereof.

20. The process of claim 19, wherein the amount of impurity in the feed stream is no more than 3,000 ppm.
